(19) United States
(12) Patent Application Publication
(10) Pub. No.: US 2022/0062079 A1
(43) Pub. Date: Mar. 3, 2022

(54) AUXILIARY TURNING-OVER DEVICE

(71) Applicant: NINGBO YLAISEN MEDICAL DEVICE CO., LTD, NINGBO (CN)

(72) Inventor: Juqing CHEN, NINGBO (CN)

(21) Appl. No.: 17/233,322

(22) Filed: Apr. 16, 2021

(30) Foreign Application Priority Data
Aug. 25, 2020 (CN) 202010864728.4
Dec. 15, 2020 (CN) 202023019814.X

(51) Int. Cl. A61G 7/00; A61G 7/10

(52) U.S. Cl. CPC A61G 7/001; A61G 7/1051; A61G 7/1044

(57) ABSTRACT

An auxiliary turning-over device is provided which comprises two parallel support frames at two sides of a sickbed respectively, two rollers rotatably connected on the two support frames, a drive mechanism respectively in drive connection with the two rollers for driving the two rollers to synchronously rotate around respective axis, and a flexible carrier arranged between the two rollers; the two ends of the flexible carrier are respectively wound on the two rollers, and when the two rollers are driven by the drive mechanism to rotate along the same direction, the flexible carrier translates and winds the other roller at the moment of being released from one roller along its translation direction. With a simplified structure, the auxiliary turning-over device help to lower the manual auxiliary labor intensity and cost when the bedridden patient turns over or goes to bed.

### CROSS-REFERENCE TO RELATED APPLICATIONS

This application claims priority to Chinese Application No. 202010864728.4, filed on Aug. 25, 2020, and Chinese Application No. 202023019814.X, filed on Dec. 15, 2020. These contents are hereby incorporated by reference.

### TECHNICAL FIELD

The present invention relates to the technical field of medical equipment, in particular to an auxiliary turning-over device.

### BACKGROUND

It is easy to cause pressure sores, bedsores or other symptoms if patients lie in bed for a long term. These symptoms can not only worsen the primary condition of the patients but also accelerate consumption of medical healthcare resources. Even worse, they raise the mortality of elderly patients by more than three times. Numerous studies show that, providing turning-over assistance for patients plays the key role in preventing pressure sores, which meanwhile satisfies requirements of patients and medical operation. Therefore, it is a very important nursing operation to turn over bedridden patients. Whereas, with regard to the existing medical beds, nursing beds and the like, if patients staying in bed want to sit up, the only way is to control the beds, but for the post-operation or critical patients, in case of wiping body or the like, these beds are helpless to assist them in lying on the side or turning over. At present, in most cases, it depends on nursing staff to manually help patients lie on the side or turn over, and this operation process is high in labor strength, low in efficiency and high in possibility of causing additional injuries to the patients. Besides, there are some auxiliary devices for bedridden patients to turn over. But most of the devices of this kind have a structure similar to the grab bucket of an excavator, thus occupying more space that is adverse to nursing and treatment of patients in sickrooms, and easily bringing discomfort to patients physically and mentally as these devices are stiff in operation in the use process and rigid in material. Furthermore, these devices are often expensive to produce and use, and thus cannot be widely used in general wards. As well, some sickbed is provided with such a bed plate structure that is able to curl from one side, which still cannot be widely used in general wards owing to its high production and use costs. Even in the use process, it may result in disordered bed mats and impede nursing and treatment operations. What's more, there is a nursing problem needing to be urgently addressed that, most of the bedridden patients difficult to go up to/go down from bed generally rely on nursing staff to do so, in such a case, more nursing staff is needed, and the operation is very labor-some and high in labor strength, and easy to injure patients due to bumps.

### SUMMARY

It is an object of the present invention to overcome the defect of the prior art, and provide an auxiliary turning-over device for solving the problems that human assistance is high in labor strength and device assistance is high in use cost when bedridden patients in the prior art want to turn over or go up to bed.

To achieve the foregoing object, the technical solution adopted by the present invention provides an auxiliary turning-over device with such a structure: it comprises two parallel support frames at two sides of a sickbed, two rollers rotatably connected on the two support frames respectively, with the axes of the two rollers parallel to each other, drive mechanisms respectively in drive connection with the two rollers for driving the two rollers to synchronously rotate around respective axis, and a flexible carrier arranged between the two rollers. Two ends of the flexible carrier are respectively wound on the two rollers, and when the two rollers are driven by the drive mechanisms to rotate along the same direction, the flexible carrier translates and winds the other roller at the moment of being released from one roller along its translation direction.

After adopting the above structure, as compared to the prior art, the auxiliary turning-over device has the following advantages that when it is in use, the two support frames are arranged at two sides of a sickbed, the flexible carrier is laid on a bed mat of the sickbed in a cross-over manner, and a patient lies on the flexible carrier; the drive mechanisms serve as power sources for turning-over operation, the flexible carrier plays the roles of a turning-over performer and a support structure of the patient, and the rollers are used as mounting connectors of the flexible carrier. When the patient needs to turn over, the drive mechanisms drive the two rollers to synchronously rotate around respective axis along the same direction, the flexible carrier translates, and the patient lying on the flexible carrier, under the effect of gravity, turns over along with the movement of the flexible carrier; or the patient lying on the flexible carrier, under the effect of a friction force between the flexible carrier and the patient, turns over along with the translation of the flexible carrier. In this solution, the support frames may abut against the sickbed, the flexible carrier is laid on the sickbed, occupied space is less, use cost is low, nursing and treatment operations are not affected, the flexible carrier is soft in texture, and the whole structure is simple and easy to produce. Independent from the sickbed in use, the auxiliary turning-over device is low in use cost and can be widely used in general wards. Moreover, as the flexible carrier is laid on the sickbed, in the operation process of the device, the patient is driven only by the flexible carrier to turn over, therefore, the bed mat laid on the sickbed does not move and thus is kept clean, nursing is easy to advance, and secondary injury to the bedridden patient is avoided.

Preferably, the support frames are arm-rest frames. The end portion of the support frame is connected with a swing arm. The end portion of the swing arm is rotatably connected on a base. The middle of the swing arm is rotatably connected with a lifting mechanism. The lifting mechanism is rotatably connected on the base. The base is fixedly connected on a headboard or footboard. In practical use, the two bases are fixed on the headboard and footboard; the support frames are arranged at the lateral ends of the bed; the flexible carrier wound on the rollers is pulled out to be laid on the bed; the base as the whole support structure provides a support for the end portions of the lifting mechanisms and the swing arms, the swing arms support the support frames, and the support frames support the rollers; the lifting mechanisms serving as the power sources of the swing arms drive the swing arms to rotate around connecting points with the bases so as to drive the support frames at the other ends of the swing arms to swing and lift at the lateral ends of the bed, thus the rollers on the support frames are driven to swing, and the end portions of the flexible carrier are driven by swinging of the rollers to lift; the drive mechanisms serving as the power sources for the rollers to wind the flexible carrier drive the flexible carrier to wind or elevate toward one side by virtue of lifting and rotation of the rollers so as to assist a bedridden patient in laterally turning over, without human assistance from nursing staff. The structure is simple and practical, and use cost is lower than that of the prior art. Besides, it is more optimized that Bluetooth or other wireless control modules may be matched with the lifting mechanisms and the drive mechanisms for use, so the bedridden patients are able to remotely control the lifting mechanisms and the drive mechanisms to act through mobile software or the like to achieve auxiliary turning-over operation by themselves with great convenience. Therefore, when the bedridden patients want to go up to/go down from bed, the operation is convenient and labor-saving by means of winding movement of the flexible carrier, and secondary injure to the bedridden patients is avoided.

Preferably, the arm-rest frames are provided with brackets. The drive mechanism is a roller motor arranged on the bracket. The end portions of the rollers are connected with roller motors. By use of the roller motors, occupied space is further reduced, the whole structure of the support frames and the rollers becomes concise, movement of the bedridden patients or laying of the bed mats is not affected, and use is convenient.

Preferably, the swing arms are of an arc shape. A plurality of lightening holes are arranged on the swing arms. Arc-shaped swing arms make the swinging angle of the arm-rest frames and the rollers wider, contributing to auxiliary turning-over operation for the bedridden patients. Due to the design of the lightening holes, the weight of the swing arms is lightened, load of the lifting mechanisms is lowered, and the swings arms are ensured to be stably and reliably driven by the lifting mechanisms to swing for a long period of time.

Preferably, the top end of the base is provided with a connecting base. The connecting base comprises a vertical connecting bar. The swing arm and the connecting bar are connected via a pin roll. The connecting base serving as a connection support of the swing arm plays an adjustment role in mounting of the swing arm.

Preferably, the connecting bar is provided with a plurality of connecting holes in the vertical direction. Due to the plurality of connecting holes, adaptive adjustment is conveniently carried out on the mounting positions of the swing arms, so that the swing arms swing in a large range and use is convenient.

Preferably, the lifting mechanism is a hydraulic rod. Both the middle of the swing arm and the base are provided with support seats on which two ear plates are arranged, the ear plates are provided with pin holes, and two ends of the hydraulic rod are connected on the support seats via pin rolls. The hydraulic rod is stable and reliable to lift and low in noise. By connecting the hydraulic rods with the support seats, assembly and disassembly become flexible, and operation is easy.

Preferably, the rollers are above the support frames. In such a case, the flexible carrier is always at one side, abutting against the bed, of the arm-rest frames in the use process, thus effectively preventing the flexible carrier from being damaged by friction on the arm-rest frames, and ensuring the flexible carrier to be effectively laid on the bed.

Preferably, the angle of the swing arms driven by the hydraulic rods to swing upward over the bed is 0-75°, such that after swinging upward, the swing arms can effectively drive the flexible carrier to reach the height where the turning-over requirement is achievable, and auxiliary turning-over operation is facilitated.

Preferably, the angle of the swing arms driven by the hydraulic rods to swing downward over the bed is 0-16°, such that after the swing arms drop down, the arm-rest frames and the rollers are closer to the underneath of the bed, thus avoiding excessively occupying lateral space of the bed or influencing movement and operation of nursing staff.

Preferably, the support frame comprises a pedestal and a rack, the pedestal is provided with a push rod, the roller is on the top end of the rack, the rack is connected above the pedestal via the push rod, and the drive mechanism is mounted on the rack. Due to this structure, the pedestals contact the ground for serving as supports, the racks are supported by the push rods to support the rollers, the whole structure is concise and flat, occupied space is less and use is convenient and rapid.

Preferably, the drive mechanism comprises a motor transversely mounted on the rack, the output shaft of the motor is connected with a drive gear, and the end portion of the roller is connected with a driven gear meshed with the drive gear. Therefore, the motor outputs a driving force that is transmitted by a gear set, so that drive to the rollers becomes automated and labor-saving, artificial turning-over operation is avoided, labor strength is low, and drive is stable and steady.

Preferably, the bottom end of the rack is provided with a U-shaped chute, a pin rod is arranged between lateral walls of the U-shaped chute, the top end of the push rod is provided with a transverse pin hole, the top end of the push rod is inserted into the U-shaped chute, and the pin rod penetrates into the pin hole. Due to this structure, the push rod is stably and reliably connected on the rack, and the U-shaped chute plays a role in effective limitation and guiding of the push rod.

Preferably, the pedestal is internally provided with a jacking-up piece, and the push rod is connected on the output end of the jacking-up piece. Due to the structure, the jacking-up piece drives the push rod to vertically lift so as to drive the rollers to lift, therefore, the flexible carrier is lifted upward before the turning-over operation, the friction force between the flexible carrier and the bed mat is reduced, turning-over operation becomes easy, and unilateral lifting is allowed so as to incline the flexible carrier to further advance auxiliary turning-over operation for patients.

Preferably, the support frame comprises two abreast pedestals and two racks corresponding to the two pedestals, the rack is embedded with a bearing, and the roller and the bearing are in interference fit. Due to this structure, the pedestals and the racks form flat support frames that abut against two sides of a sickbed, and the rollers can be effectively mounted and rotate owing to the bearings.

Preferably, the motor is arranged between two racks of a same support frame. In such a case, the motor is arranged at the inner side of the support frame, keeping a flat structure of the support frame, avoiding any protrusion in the appearance, having less influence on nursing and treatment operations, and favoring storage.

Preferably, a supporting tube is connected between two racks of a same support frame and below the motor. A lead connected with the motor penetrates into the supporting tube. Due to this structure, the supporting tube contributes to improving stability of the upper structure of the support frame, and can also accommodate the leads of the motor so as to form a hidden line, and a concise appearance has no adverse effect on nursing and treatment operations.

Preferably, the lateral end of the drive gear deviating from the motor is coaxially connected with a handle. Therefore, when the power supply of the motor is off, the handle is manually operated to rotate the rollers for turning-over operation of patients.

Preferably, the pedestal is provided with a vertical slide, the pedestal at the outer side of the slide is provided with a jacking-up piece, the drive mechanism is a ball bearing motor that is arranged on the top end of the rack and is coaxially arranged with the roller. The lateral end of the rack is slidably connected on the slide and connected with the jacking-up end of the jacking-up piece. Due to this structure, the jacking-up piece drives the rack to vertically move along the slide so that the height of the rollers is conveniently adjusted. By virtue of coaxially integrated arrangement of the ball bearing motor and the roller, occupied space is reduced, the whole structure becomes light, and auxiliary turning-over operation is facilitated as the end portions of the racks are capable of lifting independently.

Preferably, the flexible carrier is made of any one of cotton cloth, non-woven fabric, nylon cloth and the like. Therefore, the flexible carrier is connected on the rollers stably, and a human body is effectively and stably borne by the flexible carrier for auxiliary turning-over operation in the use process. The flexible carrier is preferably made of an unwoven fabric, so use cost is low, air permeability is good, texture is soft and use effect is excellent.

### BRIEF DESCRIPTION OF THE DRAWINGS

FIG. 1 is an axonometrical drawing showing bilateral swing arms in a lifting state simultaneously according to Embodiment One of the present invention;

FIG. 2 is an axonometrical drawing showing a unilateral swing arm in a lifting state according to Embodiment One of the present invention;

FIG. 3 is an axonometrical drawing showing the swing arms in a contracted state according to Embodiment One of the present invention;

FIG. 4 is an axonometrical drawing according to Embodiment Two of the present invention;

FIG. 5 is a schematic diagram showing matched use with a medical bed according to Embodiment Two of the present invention;

FIG. 6 is an enlarged view of Portion A of FIG. 4;

FIG. 7 is a schematic diagram showing connection of a handle according to Embodiment Three of the present invention;

FIG. 8 is a schematic diagram showing matched use with a medical bed according to Embodiment Three of the present invention;

FIG. 9 is an enlarged view of Portion B of FIG. 8.

### DETAILED DESCRIPTION OF THE EMBODIMENTS

The present invention will be further explained in detail in the following embodiments with reference to the appended drawings.

The reference signs in the drawings denote that: bed 1; base 2; connecting base 3; swing arm 4; support frame 5; roller 6; roller motor 7; lightening hole 8; support seat 9; connecting hole 10; connecting bar 11; hydraulic rod 12; flexible carrier 13; pedestal 14; rack 15; hydraulic cylinder 16; push rod 17; drive gear 18; driven gear 19; motor 20; stop lever 21; supporting tube 22; medical bed 23; bedstead 231; shell plate 24; handle 25; slide 26; hydraulic push rod 27; ball bearing 28; ferrule 29; push block 30; pulley 31; and strip-shaped through hole 32.

### Embodiment One

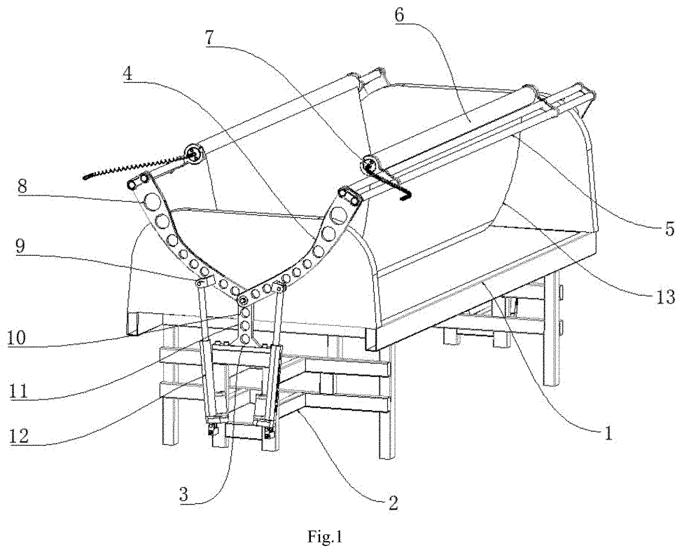

Substantially referring to FIG. 1, the present invention provides an auxiliary turning-over device, which comprises two parallel support frames 5 at two sides of a sickbed, two rollers 6 rotatably connected on the two support frames 5 respectively, with the axes of the two rollers 6 parallel to each other, drive mechanisms respectively in drive connection with the two roller 6 for driving the two rollers 6 to synchronously rotate around respective axis, and a flexible carrier 13 arranged between the two rollers 6. Two ends of the flexible carrier 13 are respectively wound on the two rollers 6, and the flexible carrier 13 translates and winds the other roller 6 at the moment of being released from one roller 6 along its translation direction when the two rollers 6 are driven by the drive mechanisms to rotate along the same direction. The auxiliary turning-over device also comprises bases 2 welded at the headboard and footboard. The end portion of the roller 6 is connected with the drive mechanism. To be specific, the support frames 5 are provided with two brackets in a sleeved manner via bolts; the drive mechanism is a roller motor 7 arranged on the bracket; the end portions of the rollers 6 are in key connection with the rollers 6 of the roller motors 7; the rollers 6 are arranged above the support frames 5 and wound on the flexible carrier 13; the flexible carrier 13 is preferably made of an unwoven fabric with its end portions glued to the rollers 6; the flexible carrier 13 may also be made of any one of cotton cloth, non-woven fabric, nylon cloth and the like.

The support frames 5 are arm-rest frames. The end portion of the support frame 5 is in bolted connection with a swing arm 4. The swing arms 4 are of an arc shape. A plurality of lightening holes 8 are arranged on the swing arms 4. The end portions of the swing arms 4 away from the support frames 5 are rotatably connected with the bases 2. To be specific, the top end of the base 2 is in bolted connection with a connecting base 3. The connecting base 3 comprises a vertical connecting bar 11, and the connecting bar 11 is provided with four connecting holes 10 in the vertical direction. The swing arm 4 is connected with the connecting hole 10 on the top end of the connecting bar 11 via a pin roll. The middle of the swing arm 4 is rotatably connected with a lifting mechanism. The lifting mechanism is rotatably connected on the base 2. The lifting mechanism is a hydraulic rod 12. Both the middle of the swing arm 4 and the base 2 are fixed with support seats 9 by bolts. The support seat 9 is integrated with two ear plates, the ear plates are provided with pin holes, and two ends of the hydraulic rod 12 are connected on the support seats 9 via pin rolls. The angle of the swing arms 4 driven by the hydraulic rods 12 to swing upward over the bed is 0-75°. The angle of the swing arms 4 driven by the hydraulic rods 12 to swing downward over the bed is 0-16°.

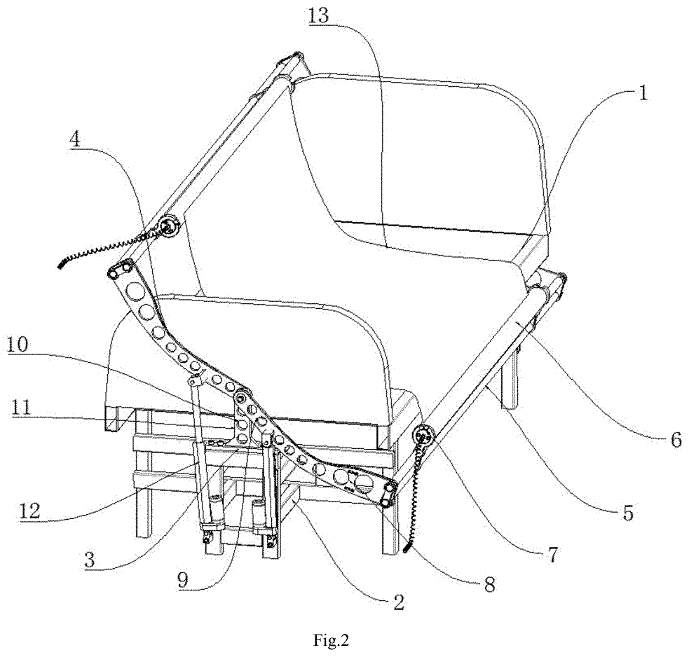

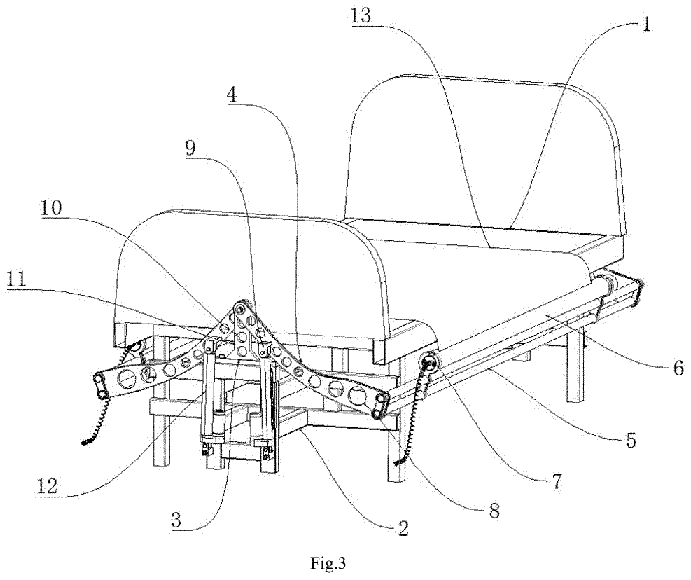

The particular implementation process is as follows: in practical use, the headboard and footboard of a bedstead are welded with a base 2 respectively; two sides of a bed 1 are respectively provided with a support frame 5; the end portion of the support frame 5 is connected with the connecting base 3 on the upper end of the base 2 through a pin roll, and is preferably connected into the connecting hole 10 on the top end of the connecting bar 11; the swing arms 4 at two sides respective abut against the front and back two sides of the connecting bar 11; a flexible carrier 13 is wound between two rollers 6 on the two support frames 5; and the roller motor 7 and the hydraulic rod 12 are connected with a controller via leads. In normal use, as shown in FIG. 3, the hydraulic rod 12 is in a contracted state so the swing arms 4 droop down below two sides of the bed 1, the swing arms 4 can be effectively contained below the bed as its maximum downward swinging angle is 16°, and the flexible carrier 13 is laid on the bed through the rollers 6 at the two sides of the bed 1. For paralyzed patients or patients with disabled lower limbs, they need nursing staff's help to go up to bed, operation is inconvenient, labor strength is high, accidental injure is easily caused. But if the device of the present invention is used, a patient is assisted to sit/lay on the edge of a bed, and then the roller motor is started so that the flexible carrier 13 is coiled toward one side so as to drive the patient to move to the middle of the bed. Or in the process, the flexible carrier 13 is lifted by the swing arms so that the flexible carrier 13 supports the patient to depart from the bed, therefore movement is smooth and the bed mat is kept tidy. Or the swing arms lift to render the patient on the flexible carrier 13 slide to the middle of the bed. As can be seen, the auxiliary turning-over device not only has the function of assisting bedridden patients to turn over but also help disabled people go up to bed. After a bedridden patient lies on the flexible carrier 13, the support frames 5 are contained below the bed 1 so as not to influence movement of the bedridden patient and nursing staff. The flexible carrier 3 made of an unwoven fabric is laid on the bed, which has no influence on movement of a bedridden patient but plays a protection role for the bed mat. If the bedridden patient needs to turn over, in combination with FIG. 2, the hydraulic rod 12 is controlled by the controller to stretch, so that the swing arms 4 swing upward around the connecting points with the connecting bars 11 to drive the support frames 5 and the rollers 6 to swing upward, and meanwhile the roller motors 7 drive the rollers 6 to rotate and release one portion of the flexible carrier 13, so that the support frames 5 and the rollers 6 are successfully lifted above the bed and the flexible carrier 13 laid on the bed is inclined, thus the bedridden patient gets an auxiliary force for turning over toward one side. The rollers 6 at two sides are controlled to swing, lift and rotate in accordance with actual requirements, and the maximum upward swinging angle of the swing arms 4 is 75°, therefore, it is effectively ensured that after the rollers 6 are lifted, the unilateral lift height of the flexible carrier 13 is sufficient to help the bedridden patient to turn over, and the bedridden patient is conveniently assisted to turn over. The whole structure is concise and practical, a soft clinging force is exerted to the bedridden patient from the flexible carrier 13 to turn over, the auxiliary turning-over process is mild, no influence on the bed mat is caused, and the device can be widely used in general wards.

As an embodiment of the present invention, on the basis of Embodiment One, the roller motors 7 and the hydraulic rods 12 are connected to a control terminal via leads. The control terminal is preferably a computer. In this embodiment, the control terminal and the bed 1 are placed in an inpatient ward together, and the control terminal is connected with a bed-carried controller via leads. In the use process of the embodiment, by virtue of the bed-carried controller, the bedridden patient gets access to convenient turning-over assistance, and the nursing staff also can help the bedridden patient to turn over using the bed-carried controller in the nursing process, therefore, use becomes convenient and rapid.

As an embodiment of the present invention, the control terminal is separately placed in a control room in which a plurality of auxiliary turning-over devices placed in a plurality of inpatient wards are under centralized control, therefore, contactless centralized management is facilitated. This solution is applied to occasions highly requiring turning-over assistance such as old people's homes, nursing homes for vegetative patients and the like.

As an embodiment of the present invention, the headboard or the swing arm 4 is provided with a surveillance camera that is connected with the control terminal via leads. Visualized remote operation of the auxiliary turning-over device is achieved by the control terminal, and auxiliary turning-over operation for the bedridden patients is conveniently and remotely facilitated

As an embodiment of the present invention, mobile software and a QR code identification technology may be supported in use. The auxiliary turning-over device with a large swing amplitude is provided with an independent QR code, the mobile software identifies the QR code to get the right to operate the corresponding auxiliary turning-over device with a large swing amplitude so that both the bedridden patients and the nursing staff can control the auxiliary turning-over device with a large swing amplitude to operate via mobile phones any time anywhere.

### Embodiment Two

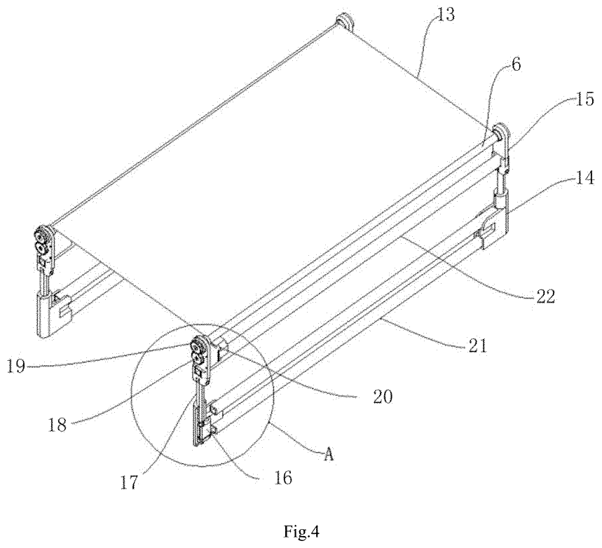

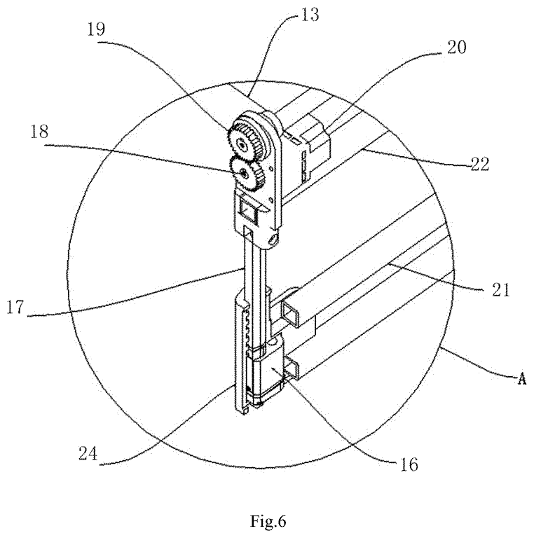

Substantially as shown in FIGS. 4 and 6, the present invention provides an auxiliary turning-over device, which comprises two parallel support frames 5. The support frame 5 comprises two abreast pedestals 14 and two racks 15 corresponding to the two pedestals 14. The pedestal 14 is formed by closure of two shell plates 24 that may be closed with each other via bolts. The pedestal 14 is internally provided with a mounting cavity. A hydraulic cylinder 16 is placed in the mounting cavity. The output shaft of the hydraulic cylinder 16 is vertically arranged upward. The top end of the output shaft of the hydraulic cylinder 16 is welded with a push rod 17. A horizontal pin hole is formed on the top end of the push rod 17. The bottom end of the rack 15 has a U-shaped chute of which the lateral wall is provided with a through hole. Through holes on the two lateral walls of the U-shaped chute are penetrated by pin rods. The top end of the push rod 17 is inserted into the U-shaped chute. The pin rod penetrates into the pin hole of the push rod 17. A roller 6 is rotatably connected between the upper ends of the two racks 15 of a same support frame. To be specific, a bearing is embedded on the upper end of the rack 15, and the roller 6 and the bearing are in interference fit. One end of the roller 6 extends out of the bearing and is in key connection with a driven gear 19. The rack 15 below the driven gear 19 is provided with a motor 20 via bolts. The motor 20 is transversely arranged below the roller 6, and the main structure of the motor 20 is arranged between the two racks 15. The rack 15 where the motor 20 is placed has a through hole corresponding to the output shaft of the motor 20. The output shaft of the motor 20 transversely passes through the rack 15 to be in key connection with a drive gear 18. The drive gear 18 and the driven gear 19 are meshed. A flexible carrier is detachably connected between the rollers 6 on two support frames. A plurality of threaded holes are axially formed on the rollers 6. Bolts are connected inside the threaded holes. The flexible carrier 13 is pressed on the rollers 6 via bolts.

A supporting tube 22 is welded between two racks 15 of a same support frame and is placed below the motor 20. A lead connected with the motor 20 penetrates into the supporting tube 22. Two vertically abreast stop levers 21 are welded between two pedestals 14 of a same support frame. The stop levers 21 play a strengthening role for the structure of the support frames.

The motors 20 on the two support frames synchronously rotate. The control circuit structure of the motor 20 comprises forward and reverse switching circuits.

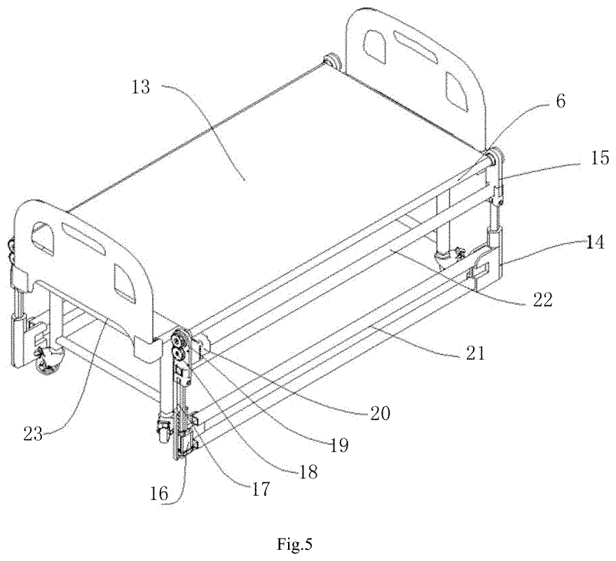

The particular implementation process is as follows: in combination with FIGS. 2 and 5, when in use, two support frames vertically abut against two sides of a medical bed 23 so that the flexible carrier 13 is laid on the bed mat of the medical bed 23 in a cross-over manner. A patient lies on the flexible carrier 13 when the medical bed 23 is used. If turning-over operation is needed in the patient nursing or treatment process, four hydraulic cylinders 16 are controlled to jack up synchronously, and the push rods 17 jack up the racks 15 so that two rollers 16 synchronously jack up and a frictional force between the flexible carrier 13 and the bed mat is relatively reduced, and the flexible carrier 13 is prevented from driving the bed mat to turn up. Then the motors 20 on the support frames are controlled to operate synchronously, so the drive gears 18 drive the driven gears 19, the driven gears 19 drive the rollers 16 to rotate, and the rollers 6 at two sides of the medical bed 23 synchronously rotate along the same direction, therefore, the flexible carrier 13 moves toward one side of the medical bed 23, and turning-over operation of the patient is achieved in the movement process. In the use process, it is also allowed that the roller 6 at one side is jacked up higher than the roller 6 at the other side, in such a case, the flexible carrier 13 is inclined to help the patient to turn over. After use, if the flexible carrier 13 is damaged or contaminated, the bolts on the rollers 6 are unscrewed, then the flexible carrier 13 is taken off from the rollers 6 to be replaced, and replacement and maintenance in accordance with the use conditions are convenient.

In this embodiment, the support frame has a flat outer structure in the use process and abuts against the medical bed 23, the flexible carrier 13 is laid on the bed mat, and the two support frames are put together when not in use, so occupied space is less. The flexible carrier 13 is laid on the bed mat so that air permeability is improved and pressure sores are avoided for patients, and turnup of the bed mat is prevented in the turning-over process of patients, nursing is facilitated, and injuries to patients are avoided due to flexible operation to the patients in the turning-over process. In this solution, under the drive of the hydraulic cylinders 16 and the motors 20, automation degree is high, labor strength of medical staff in assisting patients to turn over is lowered, and operation is convenient and rapid. Also in this solution, the whole structure is simple, raw materials are easy to obtain, the flexible carrier 13 is replaceable, production and use costs are lower than those of the existing device and medical and health requirements are well satisfied.

### Embodiment Three

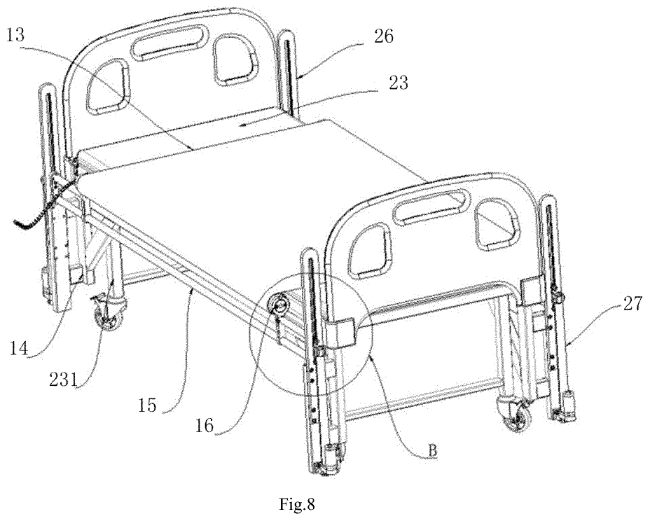

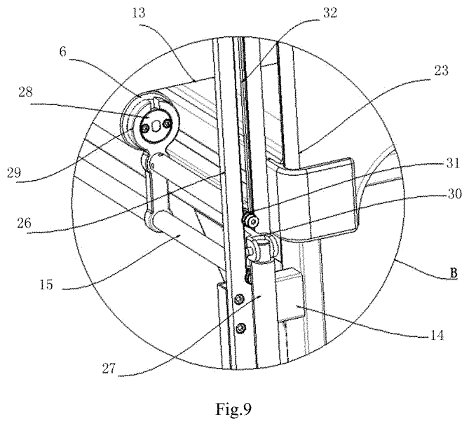

As shown in FIGS. 8 and 9, the pedestal 14 is connected on the bedstead 231 of the medical bed 23 via bolts. A vertical slide 26 is connected on the pedestal 14 via bolts. The slide 26 is a plate of which the middle is provided with a vertical strip-shaped through hole 32. The slides 26 are distributed at the outer sides of the four corners of the medical bed 23. The pedestals 14 at the outer sides of the slides 26 are connected with hydraulic push rods 27 via bolts. The drive mechanism is a ball bearing 28 motor that is arranged on the top end of the rack 15 and is coaxially arranged with the roller 6. To be specific, two abreast ferrules 29 are welded on the top ends of the racks 15. Two ball bearings 28 of the ball bearing 28 motors are connected to the two ends of the rollers 6 in an interference-fit manner. The rollers 6 are made of conductive metals. The surfaces of the rollers 6 are covered by insulated material layers. In this embodiment, the insulated material layers are rubber layers. Two ends of the rollers 6 are clamped in the ferrules 29 of the racks 15. The end portions of the racks 15 at the headboard and footboard are connected with two vertically parallel pulleys 31 via bolts. The two pulleys 31 slide in strip-shaped through holes 32 in the slides 26. A push block 30 connected with the ferrule 29 of the rack 15 is arranged between the two pulleys 31. The push block 30 penetrates through the strip-shaped through hole 32. One end of the push block 30 penetrating through the strip-shaped through hole 32 is hinged with the top end of the hydraulic push rod 27.

In this embodiment, when in use, the support frames are connected at two sides of the bedstead 231 of the medical bed 23 via the pedestals 14. The flexible carrier 13 crosses over the bed mat of the medical bed 23. Therefore, when a patient needs to turn over, the hydraulic push rods 27 at four corners of the medical bed 23 synchronously or separately lift so that the flexible carrier 13 is parallelly lifted so as to reduce a friction force with the bed mat, or the flexible carrier 13 is unilaterally lifted or lifted from one corner so as to make a patient turn over. A flat design brings the advantages of less occupied space, good auxiliary turning-over effect of patients, and more applied occasions.

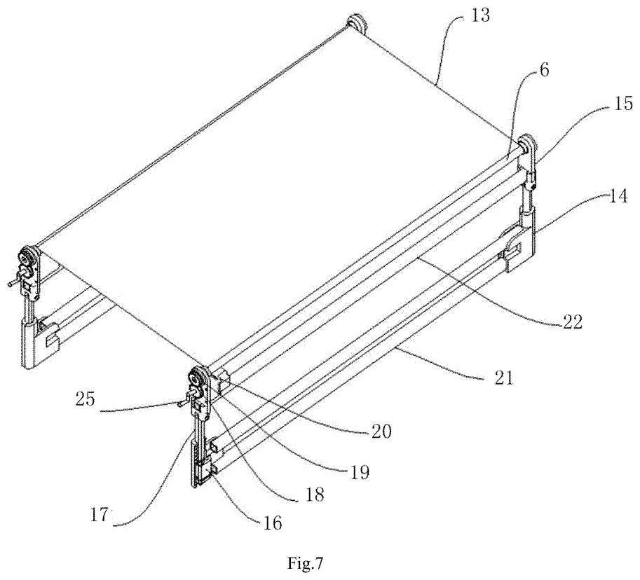

As an embodiment of the present invention, as shown in FIG. 7, the lateral end of the drive gear 18 deviating from the motor 20 is coaxially connected with a handle 25. Therefore, when the motor 20 fails to start, for example no power is supplied, the handle 25 is artificially rotated to drive the rollers 6 to rotate so as to achieve turning-over operation of patients.

As an embodiment of the present invention, the motor 20 is integrated with a Bluetooth control module or a wireless control module that can be linked with mobile APP. Therefore, artificial and intelligent two modes are provided in this solution, so when there is no nursing staff, patients can intelligently control mobile APP, and easily turn over without use of any external force. Hence, practicability is high.

The above is merely the embodiments of the present invention, and the specific structure and/or features and the like that are common knowledge in the solution are not described in detail. However, it should be pointed out that, for those skilled in the art, various variations and improvements made without departing from the structure of the present invention shall fall into the scope of the present invention, and they have no influences on the implementation effects and patent practicability of the present invention. Therefore, the claims should prevail over the protection scope of the present invention, with the particular embodiments and the like in the present invention serving for the purpose of explaining the claims.

I claim:

1. An auxiliary turning-over device, wherein it comprises two parallel support frames at two sides of a sickbed, two rollers rotatably connected on the two support frames respectively, a drive mechanism respectively in drive connection with the two rollers for driving the two rollers to synchronously rotate around respective axis, and a flexible carrier arranged between the two rollers; the two ends of the flexible carrier are respectively wound on the two rollers, and when the two rollers are driven by the drive mechanism to rotate along the same direction, the flexible carrier translates and winds the other roller at the moment of being released from one roller along its translation direction.

2. The auxiliary turning-over device of claim 1, wherein the support frames are arm-rest frames; the end portion of each support frame is connected with a swing arm; the end portion of each swing arm is rotatably connected on a base; the middle of each swing arm is rotatably connected with a lifting mechanism; the lifting mechanism is rotatably connected on the base; the base is fixedly connected on a headboard or footboard.

3. The auxiliary turning-over device of claim 2, wherein the swing arms are of an arc shape; a plurality of lightening holes are arranged on the swing arms.

4. The auxiliary turning-over device of claim 3, wherein the top end of each base is provided with a connecting base; the connecting base comprises a vertical connecting bar; the swing arm and the connecting bar are connected through a pin roll.

5. The auxiliary turning-over device of claim 4, wherein the connecting bar is provided with a plurality of connecting holes in the vertical direction.

6. The auxiliary turning-over device of claim 5, wherein the lifting mechanism is a hydraulic rod, and both the middle of the swing arm and the base are provided with support seats on which two ear plates are arranged; the ear plates are provided with pin holes, and two ends of the hydraulic rod are connected on the support seats through pin rolls.

7. The auxiliary turning-over device of claim 6, wherein the rollers are above the support frames.

8. The auxiliary turning-over device of claim 7, wherein the angle of the swing arms driven by the hydraulic rods to swing upward over the bed is 0-75°.

9. The auxiliary turning-over device of claim 8, wherein the angle of the swing arms driven by the hydraulic rods to swing downward over the bed is 0-16°.

10. The auxiliary turning-over device of claim 1, wherein the support frame comprises a pedestal and a rack, the pedestal is provided with a push rod, the roller is on the top end of the rack, the rack is connected above the pedestal via the push rod, and the drive mechanism is mounted on the rack.

11. The auxiliary turning-over device of claim 10, wherein the drive mechanism comprises a motor transversely mounted on the rack, the output shaft of the motor is connected with a drive gear, and the end portion of the roller is connected with a driven gear meshed with the drive gear.

12. The auxiliary turning-over device of claim 11, wherein the bottom end of the rack is provided with a U-shaped chute, a pin rod is arranged between lateral walls of the U-shaped chute, the top end of the push rod is provided with a transverse pin hole, the top end of the push rod is inserted into the U-shaped chute, and the pin rod penetrates into the pin hole.

13. The auxiliary turning-over device of claim 12, wherein the pedestal is internally provided with a jacking-up piece, and the push rod is connected on the output end of the jacking-up piece.

14. The auxiliary turning-over device of claim 13, wherein the support frame comprises two abreast pedestals and two racks corresponding to the two pedestals, the rack is embedded with a bearing, and the roller and the bearing are in interference fit.

15. The auxiliary turning-over device of claim 14, wherein the motor is arranged between two racks of a same support frame.

16. The auxiliary turning-over device of claim 15, wherein a supporting tube is connected between two racks of a same support frame and below the motor, and a lead connected with the motor penetrates into the supporting tube.

17. The auxiliary turning-over device of claim 16, wherein the lateral end of the drive gear deviating from the motor is coaxially connected with a handle.

18. The auxiliary turning-over device of claim 11, wherein the pedestal is provided with a vertical slide, the pedestal at the outer side of the slide is provided with a jacking-up piece; the drive mechanism is a ball bearing motor that is arranged on the top end of the rack and is coaxially arranged with the roller; the lateral end of the rack is slidably connected on the slide and connected with the jacking-up end of the jacking-up piece.

19. The auxiliary turning-over device of claim 1, the flexible carrier is made of any one of a piece of cotton cloth, an unwoven fabric, a nylon cloth and the like.
